(19) United States
(12) Patent Application Publication
(10) Pub. No.: US 2026/0079076 A1
(43) Pub. Date: Mar. 19, 2026

(54) OPTICAL TRANSMISSION LINE MONITORING SYSTEM, OPTICAL TRANSMISSION LINE MONITORING METHOD, AND NON-TRANSITORY COMPUTER READABLE MEDIUM

(71) Applicant: NEC Corporation, Tokyo (JP)

(72) Inventor: Keiichi MATSUMOTO, Tokyo (JP)

(73) Assignee: NEC Corporation, Tokyo (JP)

(21) Appl. No.: 19/317,502

(22) Filed: Sep. 3, 2025

(30) Foreign Application Priority Data
Sep. 18, 2024 (JP) 2024-160991

(51) Int. Cl. G01M 11/00

(52) U.S. Cl. CPC G01M 11/31

(57) ABSTRACT

An optical transmission line monitoring system according to the present disclosure includes a first optical transmission line and a first delay optical transmission line for propagating a first monitoring light, a second optical transmission line and a second delay optical transmission line for propagating a second monitoring light, and a detection unit for identifying, based on a time at which the first monitoring light is acquired via the first optical transmission line and the first delay optical transmission line and a time at which the second monitoring light is acquired via the second optical transmission line and the second delay optical transmission line, the first monitoring light as a monitoring light propagated through the first optical transmission line and the second monitoring light as a monitoring light propagated through the second optical transmission line.

### INCORPORATION BY REFERENCE

This application is based upon and claims the benefit of priority from Japanese patent application No. 2024-160991, filed on September 18, 2024, the disclosure of which is incorporated herein in its entirety by reference.

### TECHNICAL FIELD

The present disclosure relates to an optical transmission line monitoring system, an optical transmission line monitoring method, and a non-transitory computer readable medium.

### BACKGROUND ART

In a long-distance optical transmission system such as a seabed optical transmission system, a monitoring device for monitoring a state of an optical transmission line including an optical repeater, an optical fiber, and the like is known. The monitoring device first outputs the monitoring light to an upstream optical transmission line. The output monitoring light is reflected by the optical repeater and is input as return light to the monitoring device via a downlink optical transmission line. Then, the monitoring device detects abnormality of the optical transmission line based on the acquired return light. In a case where the upstream optical transmission line and the downstream optical transmission line form one optical transmission line (or one optical transmission line system), the monitoring device monitors the state of the optical transmission line by sequentially performing these operations for each optical transmission line.

With an increase in demand for large-capacity communication, the number of installed optical transmission lines is increasing. Therefore, if the monitoring device performs monitoring for each optical transmission line, the time required for monitoring increases, and the warning immediacy upon detecting an abnormality is impaired. Therefore, an optical transmission line monitoring system capable of efficiently monitoring a great number of optical transmission lines has been proposed (e.g., JP 2024-060657 A).

### SUMMARY

Not limited to the system disclosed in JP 2024-060657 A, there is a demand for an optical transmission line monitoring system capable of efficiently monitoring a great number of optical transmission lines.

An example object of the present disclosure is to provide an optical transmission line monitoring system, an optical transmission line monitoring method, and a control program that solve the above-described problems.

An optical transmission line monitoring system according to an example aspect of the present disclosure includes a first optical transmission line and a first delay optical transmission line for propagating a first monitoring light, a second optical transmission line and a second delay optical transmission line for propagating a second monitoring light, and a detection unit for identifying, based on a time at which the first monitoring light is acquired via the first optical transmission line and the first delay optical transmission line and a time at which the second monitoring light is acquired via the second optical transmission line and the second delay optical transmission line, the first monitoring light as a monitoring light propagated through the first optical transmission line and the second monitoring light as a monitoring light propagated through the second optical transmission line, in which a length of the first delay optical transmission line is different from a length of the second delay optical transmission line.

An optical transmission line monitoring method according to an example aspect of the present disclosure includes: a step of acquiring a first monitoring light via a first optical transmission line and a first delay optical transmission line, and a second monitoring light via a second optical transmission line and a second delay optical transmission line having a length different from the first delay optical transmission line, and a step of identifying, based on a time at which the first monitoring light is acquired and a time at which the second monitoring light is acquired, the first monitoring light as a monitoring light propagated through the first optical transmission line and the second monitoring light as a monitoring light propagated through the second optical transmission line.

A control program according to an example aspect of the present disclosure for causing a computer to execute processing of: acquiring a first monitoring light via a first optical transmission line and a first delay optical transmission line, and a second monitoring light via a second optical transmission line and a second delay optical transmission line having a length different from the first delay optical transmission line, and identifying, based on a time at which the first monitoring light is acquired and a time at which the second monitoring light is acquired, the first monitoring light as a monitoring light propagated through the first optical transmission line and the second monitoring light as a monitoring light propagated through the second optical transmission line.

The optical transmission line monitoring system, the optical transmission line monitoring method, and the control program according to one example aspect of the present disclosure can efficiently monitor a great number of optical transmission lines.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram illustrating an example of a configuration of an optical transmission line monitoring system according to the present disclosure;

FIG. 2 is a diagram illustrating an example of another configuration of an optical transmission line monitoring system according to the present disclosure;

FIG. 3 is a diagram illustrating an example of a configuration of an optical repeater according to the present disclosure;

FIG. 4 is a flowchart illustrating an example of an optical transmission line monitoring method according to the present disclosure;

FIG. 5 is a diagram illustrating an example of another configuration of an optical transmission line monitoring system according to the present disclosure; and

FIG. 6 is a block diagram illustrating an example of a hardware configuration that implements a monitoring function of the optical transmission line monitoring device according to the present disclosure.

### EXAMPLE EMBODIMENT

### (First Example Embodiment)

### <Configuration of Optical Transmission Line Monitoring System>

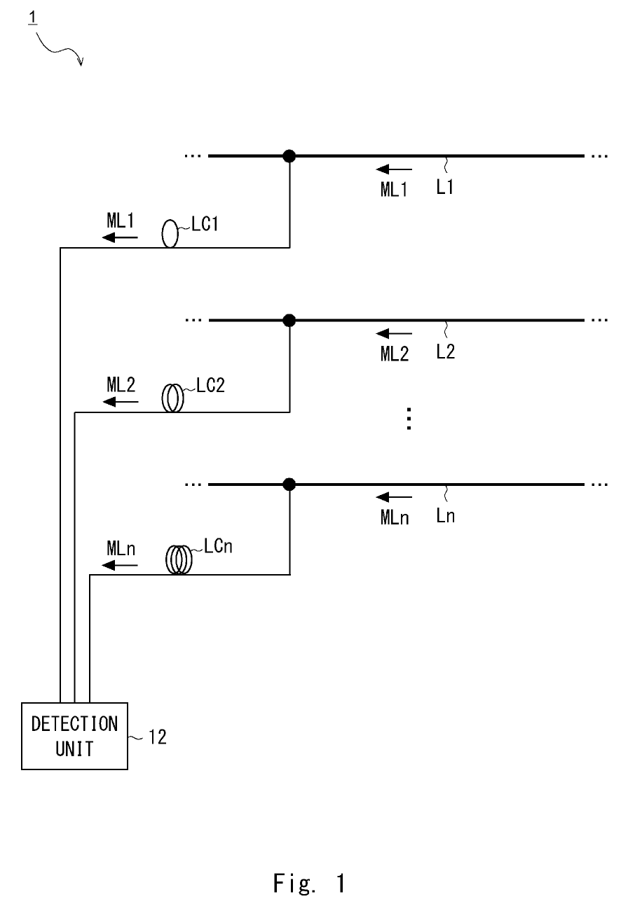

Hereinafter, a configuration example of the optical transmission line monitoring system 1 will be described with reference to FIG. 1. FIG. 1 is a diagram illustrating an example of a configuration of an optical transmission line monitoring system according to the present disclosure. An optical transmission line monitoring system 1 is a system for detecting failures in optical transmission lines L1 to Ln (n is an integer equal to or more than two) constituting various optical networks such as, for example, a seabed optical network. The optical transmission line monitoring system 1 includes a detection unit 12, optical transmission lines L1 to Ln, and delay optical transmission lines LC1 to LCn (n is an integer equal to or more than two).

The detection unit 12 detects abnormality of the optical transmission lines L1 to Ln based on monitoring lights ML1 to MLn (n is an integer equal to or more than two) propagating through the optical transmission lines L1 to Ln. More specifically, the detection unit 12 determines the type and degree of the abnormality in the optical transmission lines L1 to Ln based on, for example, the variation amount and variation pattern of the intensities of the acquired monitoring lights ML1 to MLn.

The delay optical transmission lines LC1 to LCn delay the time during which the detection unit 12 acquires the monitoring lights ML1 to MLn. Each of the delay optical transmission lines LC1 to LCn is connected to each of the optical transmission lines L1 to Ln. Lengths of the delay optical transmission lines LC1 to LCn are different from each other. As a result, the delay amount of the monitoring lights ML1 to MLn is different for every optical transmission line L1 to Ln. Thus, the time during which the detection unit 12 acquires the monitoring lights ML1 to MLn is different for every optical transmission line L1 to Ln. Therefore, it is possible to prevent the waveforms of the monitoring lights ML1 to MLn acquired by the detection unit 12 from overlapping. Furthermore, the detection unit 12 can identify through which optical transmission lines L1 to Ln the acquired monitoring lights ML1 to MLn have propagated, based on the time during which the monitoring lights ML1 to MLn are acquired.

The identification method by the detection unit 12 will be specifically described. The detection unit 12 acquires the first monitoring light ML1 via the first optical transmission line L1 and the first delay optical transmission line LC1. In addition, the detection unit 12 acquires the second monitoring light ML2 via the second optical transmission line L2 and the second delay optical transmission line LC2. Here, the length of the first delay optical transmission line LC1 is different from the length of the second delay optical transmission line LC2. Therefore, the time during which the detection unit 12 acquires the first monitoring light ML1 is different from the time during which the detection unit 12 acquires the second monitoring light ML2. For example, in a case where the first delay optical transmission line LC1 is longer than the second delay optical transmission line LC2, the time during which the detection unit 12 acquires the first monitoring light ML1 is later than the time during which the detection unit 12 acquires the second monitoring light ML2.

The detection unit 12 identifies the first monitoring light ML1 as the monitoring light propagated through the first optical transmission line L1 and the second monitoring light ML2 as the monitoring light propagated through the second optical transmission line L2 based on the time at which the first monitoring light ML1 is acquired and the time at which the second monitoring light ML2 is acquired. More specifically, the detection unit 12 identifies through which optical transmission line each of the acquired first monitoring light ML1 and the acquired second monitoring light ML2 has propagated by the difference between the time at which the first monitoring light ML1 is acquired and the time at which the second monitoring light ML2 is acquired.

As described above, in the optical transmission line monitoring system 1, the time during which the detection unit 12 acquires the monitoring lights ML1 to MLn differs for each of the optical transmission lines L1 to Ln due to the delay optical transmission lines LC1 to LCn having different lengths from each other. Furthermore, the detection unit 12 can identify through which optical transmission line L1 to Ln the acquired monitoring lights ML1 to MLn have propagated, based on the time during which the monitoring lights ML1 to MLn are acquired. Therefore, the optical transmission line monitoring system 1 can efficiently monitor a great number of optical transmission lines L1 to Ln.

### (Second Example Embodiment)

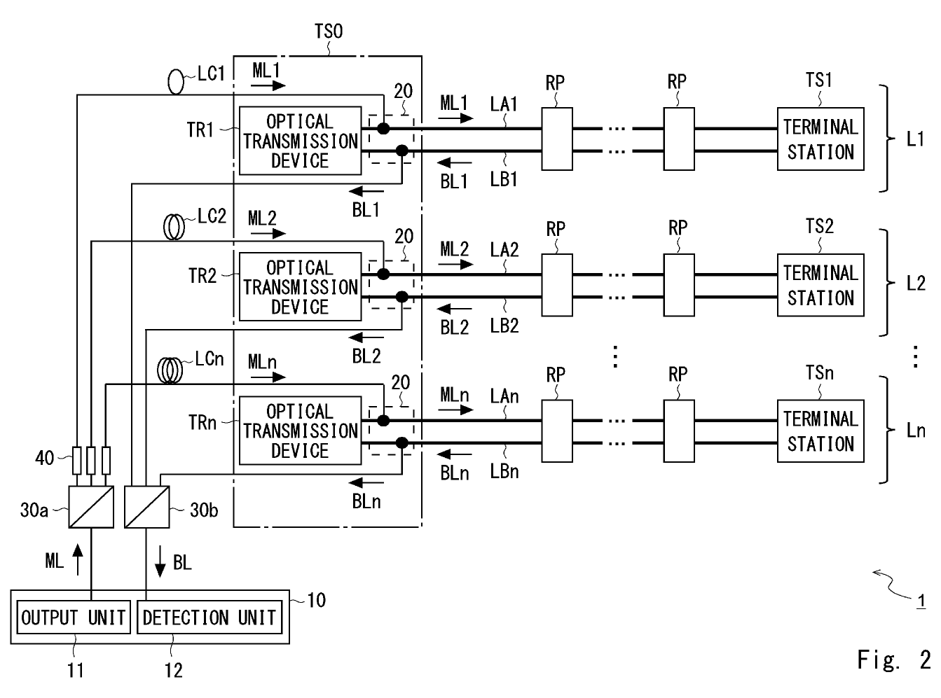

Hereinafter, another example of the optical transmission line monitoring system will be described with reference to FIG. 2. FIG. 2 is a diagram illustrating an example of another configuration of an optical transmission line monitoring system according to the present disclosure.

### <Configuration of Optical Transmission Line>

First, the optical transmission lines L1 to Ln will be described. The optical transmission lines L1 to Ln include upstream transmission lines LA1 to LAn and downstream transmission lines LB1 to LBn. One end of each of the optical transmission lines L1 to Ln is connected to a terminal station TS0, and the other end is connected to any of the terminal stations TS1 to TSn (n is an integer equal to or more than two). In addition, one or more optical repeaters RP are inserted onto the optical transmission lines L1 to Ln.

The terminal station TS0 is connected to each of a plurality of terminal stations TS1 to TSn via optical transmission lines L1 to Ln. The terminal stations TS1 to TSn are not necessarily limited to separate terminal stations. For example, some or all of the terminal stations TS1 to TSn may be provided in one terminal station. The terminal station TS0 includes a plurality of optical transmission devices TR1 to TRn. Each of the optical transmission devices TR1 to TRn includes a transmitter and a receiver (not illustrated). Similarly, each of the terminal stations TS1 to TSn includes a transmitter and a receiver (not illustrated).

The optical signals output from the transmitters of the optical transmission devices TR1 to TRn are transmitted to the receivers of the terminal stations TS1 to TSn via the upstream transmission lines LA1 to LAn. The optical signals output from the transmitters of the terminal stations TS1 to TSn are transmitted to the receivers of the optical transmission devices TR1 to TRn of the terminal station TS0 via the downstream transmission lines LB1 to LBn. In other words, the upstream transmission line LAk (k is an integer equal to or more than one and equal to or less than n) and the downstream transmission line LBk constitute an optical transmission line Lk that connects the optical transmission device TRk of the terminal station TS0 and the terminal station TSk.

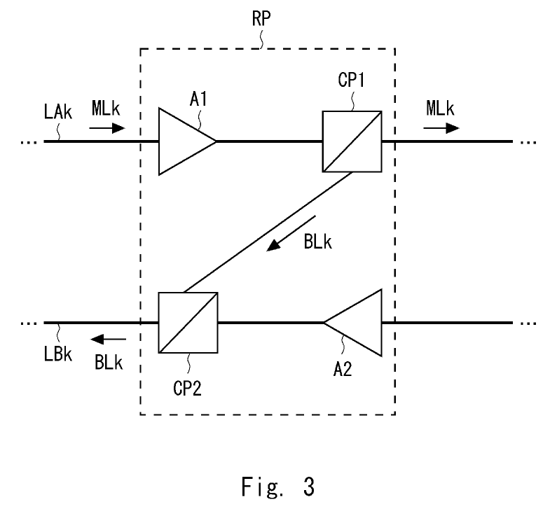

The optical repeater RP is inserted onto the optical transmission lines L1 to Ln. FIG. 3 is a diagram illustrating an example of a configuration of an optical repeater according to the present disclosure. As illustrated in FIG. 3, the optical repeater RP includes optical amplifiers A1 and A2 and couplers CP1 and CP2.

The optical amplifier A1 is inserted into the upstream transmission line LAk. The optical amplifier A1 amplifies an optical signal transmitted toward the terminal station TSk through the upstream transmission line LAk.

The coupler CP1 is configured as, for example, a directional coupler or an optical circulator. The coupler CP1 is inserted into the upstream optical transmission line LAk at the subsequent stage of the optical amplifier A1. The coupler CP1 selectively branches an optical signal (i.e., return light BLk to be described later) propagating in the opposite direction to the optical signal transmitted toward the terminal station TSk through the upstream optical transmission line LAk, and outputs the branched optical signal to the coupler CP2.

The optical amplifier A2 is inserted into the downstream transmission line LBk. The optical amplifier A2 amplifies the optical signal transmitted through the downstream transmission line LBk.

Similarly to the coupler CP1, the coupler CP2 is configured as, for example, a directional coupler or an optical circulator. The coupler CP2 is inserted into the subsequent stage of the optical amplifier A2. The coupler CP2 couples the optical signal (return light BLk) output from the coupler CP1 to the downstream transmission line LBk. As a result, the coupled optical signal (return light BLk) is transmitted to the terminal station TS0 through the downstream transmission line LBk. The coupler CP2 may be inserted into the preceding stage of the optical amplifier A2, and the coupler CP2 may couple the optical signal (return light BLk) output from the coupler CP1 to the downstream transmission line LBk, and the coupled light (return light BLk) may be input to the optical amplifier A2. In this case, the optical amplifier A2 may amplify and output the input light (return light BLk).

### <Configuration of Optical Transmission Line Monitoring System>

The description returns to FIG. 2. Next, a configuration of the optical transmission line monitoring system 1 will be described. The optical transmission line monitoring system 1 is a system for detecting failures in the optical transmission lines L1 to Ln. The optical transmission line monitoring system 1 includes a monitoring device 10, a connection unit 20, couplers 30a and 30b, a variable optical attenuator 40, delay optical transmission lines LC1 to LCn (n is an integer equal to or more than two), and the optical transmission lines L1 to Ln described above.

The monitoring device 10 is a device for detecting abnormality of the optical transmission lines L1 to Ln. The monitoring device 10 includes an output unit 11 and a detection unit 12. The output unit 11 and the detection unit 12 may be provided in separate monitoring devices 10, respectively.

The output unit 11 outputs the monitoring light ML toward the upstream transmission lines LA1 to LAn. The monitoring light ML output from the output unit 11 is branched into a plurality of monitoring lights ML1 to MLn by the coupler 30a before being input to the upstream transmission lines LA1 to LA. Then, the monitoring lights ML1 to MLn are input to the upstream transmission lines LA1 to LA, respectively.

The detection unit 12 detects abnormality of the optical transmission lines L1 to Ln based on the monitoring light propagating through the optical transmission lines L1 to Ln. The monitoring light acquired by the detection unit 12 is a monitoring light (hereinafter return lights BL1 to BLn) obtained by reflecting the monitoring light ML1 to MLn output from the output unit 11 by the optical repeater RP. The detection unit 12 determines the type and degree of the abnormality in the optical transmission lines L1 to Ln based on, for example, a variation amount and a variation pattern of the intensities of the return lights BL1 to BLn. The return lights BL1 to BLn are coupled to the return light BL by the coupler 30b and input to the detection unit 12. Coupling of the return light by the coupler 30b is not essential. Therefore, the optical transmission line monitoring system 1 may not include the coupler 30b.

The connection unit 20 is provided to connect the monitoring device 10 and the optical transmission lines L1 to Ln. A connection point connecting the output unit 11 and the upstream transmission lines LA1 to LAn and a connection point connecting the detection unit 12 and the downstream transmission lines LB1 to LBn are located in the connection unit 20. The connection unit 20 is provided, for example, at the terminal station TS0, but is not limited thereto. The connection unit 20 may be provided, for example, in the optical repeater RP or in the terminal stations TS1 to TSn. In addition, the optical transmission line monitoring system 1 may use an Open Cable Interface (OCI) as the connection unit 20.

The variable optical attenuator 40 is provided at the subsequent stage of the coupler 30a and at the preceding stage of the upstream transmission lines LA1 to LAn. The variable optical attenuator 40 is actuated in a case where it is desired to detect an abnormality in the specific optical transmission line L1 to Ln. The variable optical attenuator 40 is not an essential element. Therefore, the optical transmission line monitoring system 1 may not include the variable optical attenuator 40.

Each of the delay optical transmission lines LC1 to LCn is connected to each of the optical transmission lines L1 to Ln. More specifically, the delay optical transmission lines LC1 to LCn are installed, for example, in at least one of on the output unit 11 side from a connection point connecting the output unit 11 and the upstream transmission lines LA1 to LAn, the detection unit 12 side from a connection point connecting the detection unit 12 and the downstream transmission lines LB1 to LBn, or inside the optical repeater RP.

The delay optical transmission lines LC1 to LCn delay the time during which the detection unit 12 acquires the return lights BL1 to BLn. Lengths of the delay optical transmission lines LC1 to LCn are different from each other. As a result, the delay amount of the monitoring lights ML1 to MLn is different for every optical transmission line L1 to Ln. Therefore, the time during which the detection unit 12 acquires the return lights BL1 to BLn is different for every optical transmission line L1 to Ln depending on the delay optical transmission lines LC1 to LCn. Therefore, it is possible to suppress the waveforms of the return lights BL1 to BLn acquired by the detection unit 12 from overlapping. Furthermore, the detection unit 12 can identify through which optical transmission line L1 to Ln the acquired return light BL1 to BLn has propagated, based on the time at which the return lights BL1 to BLn are acquired.

Here, the lengths of the delay optical transmission lines LC1 to LCn are preferably longer than a value obtained by converting the pulse width of the monitoring light ML into a distance. As a result, the optical transmission line monitoring system 1 can suppress the waveforms of the return lights BL1 to BLn input to the detection unit 12 from overlapping each other. Therefore, the optical transmission line monitoring system 1 can identify through which optical transmission line L1 to Ln the return light BL1 to BLn has propagated. The value obtained by converting the pulse width of the monitoring lights ML1 to MLn into the distance is, for example, a value obtained by multiplying the pulse width of the monitoring light ML by the speed of light.

In addition, the lengths of the delay optical transmission lines LC1 to LCn are preferably shorter than a value obtained by dividing the minimum value of the span lengths of the optical transmission lines L1 to Ln by the number of the optical transmission lines L1 to Ln. As a result, the optical transmission line monitoring system 1 can suppress the waveforms of the return lights BL1 to BLn reflected by the first optical repeater RP and the waveforms of the return lights BL1 to BLn reflected by the second optical repeater RP from overlapping with each other in the return lights BL1 to BLn input to the detection unit 12. Therefore, the optical transmission line monitoring system 1 can identify through which optical transmission line L1 to Ln the return light BL1 to BLn has propagated. The span length is the length of the optical transmission line between the adjacent optical repeaters RP on the optical transmission lines L1 to Ln.

### <Optical Transmission Line Monitoring Method>

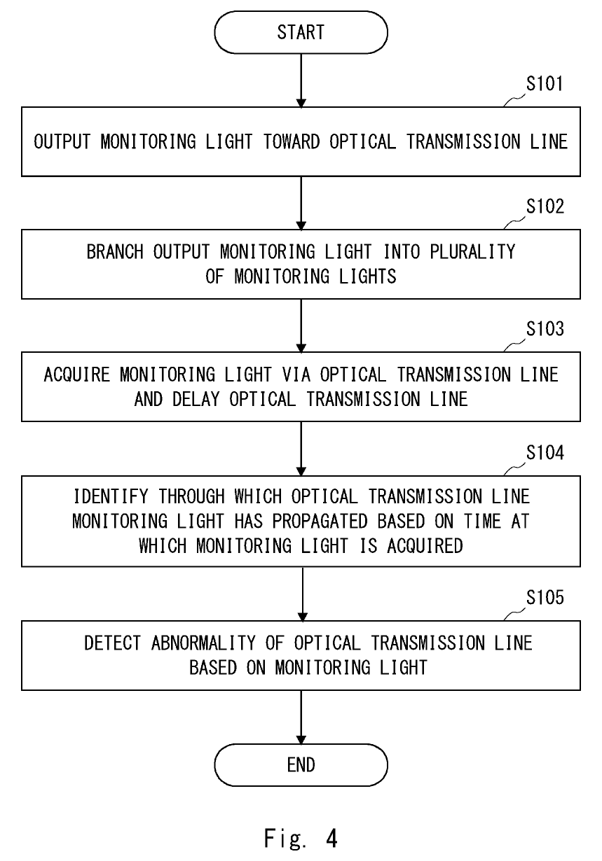

Next, processing executed by the optical transmission line monitoring system 1 will be described with reference to FIG. 4. FIG. 4 is a flowchart illustrating an example of an optical transmission line monitoring method according to the present disclosure. The flowchart illustrated in FIG. 4 is started with, for example, the acquisition of some kind of command signal by the monitoring device 10 as a trigger. Alternatively, the flowchart illustrated in FIG. 4 may be started every predetermined time.

First, the output unit 11 outputs the monitoring light ML toward the optical transmission lines L1 to Ln (step S101). More specifically, the output unit 11 outputs the monitoring light ML toward the upstream transmission lines LA1 to LAn.

Next, the coupler 30a branches the output monitoring light ML into a plurality of monitoring lights ML1 to MLn (step S102). Here, the coupler 30a branches the monitoring light ML before being input to the upstream transmission lines LA1 to LA. Then, the monitoring lights ML1 to MLn are input to the upstream transmission lines LA1 to LA, respectively.

Next, the detection unit 12 acquires the monitoring light via the optical transmission lines L1 to Ln and the delay optical transmission lines LC1 to LCn (step S103). The monitoring light acquired by the detection unit 12 is the return lights BL1 to BLn obtained by reflecting the monitoring lights ML1 to MLn branched in step 102 by the optical repeater RP. The detection unit 12 acquires the first monitoring light (return light BL1) via the first optical transmission line L1 and the first delay optical transmission line LC1. Furthermore, the detection unit 12 acquires the second monitoring light (return light BL2) via the second optical transmission line L2 and the second delay optical transmission line LC2. The length of the first delay optical transmission line LC1 is different from the length of the second delay optical transmission line LC2.

Next, the detection unit 12 identifies through which optical transmission line the monitoring light (return light BL1 to BLn) has propagated based on the time at which the monitoring light (return light BL1 to BLn) has been acquired (step S104). More specifically, the detection unit 12 identifies the first monitoring light ML1 as the monitoring light propagated through the first optical transmission line L1 and the second monitoring light ML2 as the monitoring light propagated through the second optical transmission line L2 based on the time at which the first monitoring light ML1 is acquired and the time at which the second monitoring light ML2 is acquired.

Finally, the detection unit 12 detects the abnormality of the optical transmission lines L1 to Ln based on the monitoring light (return light BL1 to BLn) (step S105). For example, the detection unit 12 determines the type and degree of the abnormality in the optical transmission lines L1 to Ln based on the variation amount and variation pattern of the intensities of the acquired monitoring lights (return lights BL1 to BLn).

As described above, in the optical transmission line monitoring system 1, the time during which the detection unit 12 acquires the monitoring light (return lights BL1 to BLn) differs for each of the optical transmission lines L1 to Ln due to the delay optical transmission lines LC1 to LCn having different lengths from each other. Therefore, the detection unit 12 can identify through which optical transmission line L1 to Ln the acquired monitoring light (return light BL1 to BLn) has propagated, based on the time at which the monitoring light (return light BL1 to BLn) is acquired. As a result, the optical transmission line monitoring system 1 can monitor the optical transmission lines L1 to Ln almost simultaneously only by outputting one monitoring light ML. Therefore, the optical transmission line monitoring system 1 can efficiently monitor a great number of optical transmission lines L1 to Ln.

### <Third Example Embodiment>

Hereinafter, the third example embodiment will be described focusing on differences from the second example embodiment. The optical transmission line monitoring system 1 according to the second example embodiment includes delay optical transmission lines LC1 to LCn having different lengths in order to identify through which optical transmission line L1 to Ln each monitoring light (return light BL1 to BLn) acquired by the detection unit 12 has propagated.

However, for example, in a case where the optical transmission lines L1 to Lk are trunk paths and the optical transmission lines Lk to Ln are branch paths, there is a possibility that the waveform of any of the return lights BL1 to BLk propagated through the optical transmission lines L1 to Lk overlaps the waveform of any of the return lights BLk to BLn propagated through the optical transmission lines Lk to Ln.

Therefore, the optical transmission line monitoring system 1 according to the third example embodiment also identifies whether the acquired monitoring light (return light BL1 to BLn) has propagated through the trunk path or the branch path.

### <Configuration of Optical Transmission Line Monitoring System>

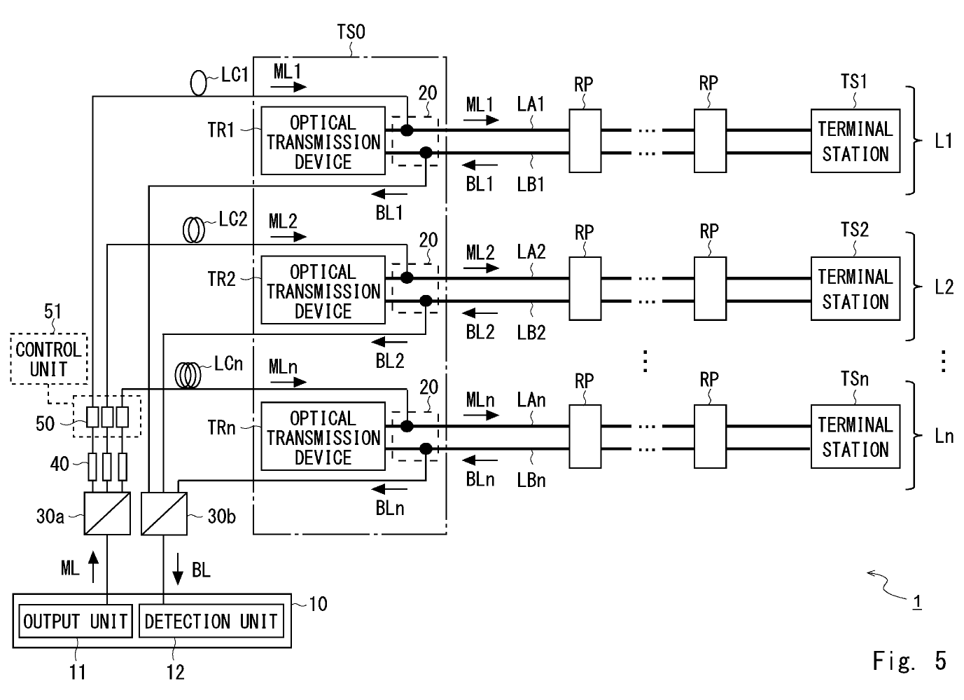

Another example of the optical transmission line monitoring system will be described with reference to FIG. 5. FIG. 5 is a diagram illustrating an example of another configuration of an optical transmission line monitoring system according to the present disclosure. As illustrated in FIG. 5, the optical transmission line monitoring system 1 according to the third example embodiment further includes a bandpass filter 50 and a control unit 51 as compared with the optical transmission line monitoring system 1 illustrated in FIG. 2. Each of the optical transmission lines L1 to Ln is either a trunk path or a branch path, at least one of the optical transmission lines L1 to Ln is a trunk path, and at least one of the optical transmission lines L1 to Ln is a branch path. Here, the optical transmission lines L1 to Lk are set as trunk paths, and the optical transmission lines Lk to Ln are set as branch paths.

The bandpass filter 50 is provided in the optical transmission line monitoring system 1 by the number of optical transmission lines L1 to Ln to be monitored. In the third example embodiment, the bandpass filter 50 is provided on the output unit 11 side from the connection point connecting the output unit 11 and the upstream transmission lines LA1 to LAn, but is not particularly limited thereto. For example, the bandpass filter 50 may be provided on the detection unit 12 side from a connection point connecting the detection unit 12 and the downstream transmission lines LB1 to LBn.

The bandpass filter 50 transmits light having a predetermined wavelength. The transmission wavelengths of the bandpass filters 50 corresponding to the trunk paths L1 to Lk are different from the transmission wavelengths of the bandpass filters 50 corresponding to the branch paths Lk to Ln. As a result, the detection unit 12 acquires monitoring lights (return lights BLk to BLn) having a wavelength different from that of the monitoring lights (return lights BL1 to BLk) acquired from the trunk paths L1 to Lk from the branch paths Lk to Ln. Then, the detection unit 12 can identify through which optical transmission line L1 to Ln the acquired monitoring light (return light BL1 to BLn) has propagated based on the time at which the monitoring light (return light BL1 to BLn) is acquired and the wavelength of the monitoring light (return light BL1 to BLn).

The control unit 51 is connected to the bandpass filter 50 and controls the transmission wavelength of the bandpass filter 50. The control unit 51 may, for example, receive an identification signal indicating which of the trunk path or the branch path each of the plurality of optical transmission lines L1 to Ln indicates, and control the transmission wavelength of the bandpass filter 50 based on the identification signal.

As described above, in the optical transmission line monitoring system 1, by providing the bandpass filter 50, the detection unit 12 can identify whether the acquired monitoring light (return light BL1 to BLk) has propagated through the trunk path or the branch path based on the wavelength of the monitoring light (return light BL1 to BLn). As a result, even if the waveforms of the return lights BL1 to BLn overlap with each other, the detection unit 12 can identify through which optical transmission line L1 to Ln the acquired monitoring light (return light BL1 to BLn) has propagated.

The method of identifying whether the acquired monitoring light (return light) has propagated through the trunk path or the branch path is not limited to the method using the bandpass filter 50. For example, the output unit 11 may output the monitoring light having a wavelength different from that of the monitoring light output to the trunk path to the branch path, and perform the identification based on the wavelength of the acquired monitoring light (return light). In addition, the overlapping of the waveforms of the return lights may be suppressed by adjusting the length of the delay optical transmission line to a length at which the time the monitoring light (return light) propagated through the trunk path is acquired does not match the time the monitoring light (return light) propagated through the branch path is acquired.

### <Configuration of Hardware for Implementing Monitoring Function of Optical Transmission Line Monitoring System>

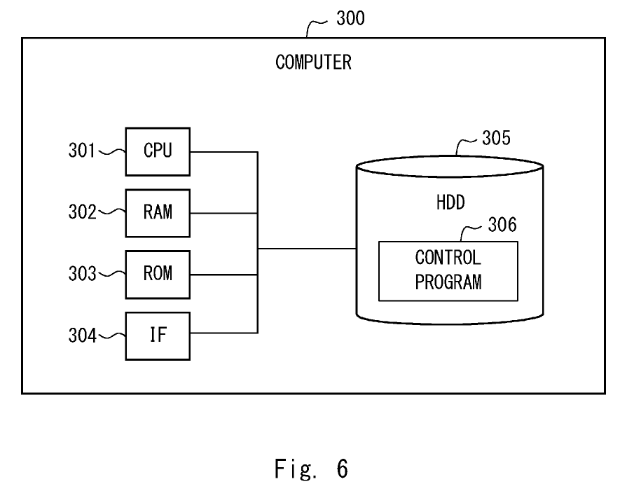

The monitoring device 10, the connection unit 20, the couplers 30a and 30b, the variable optical attenuator 40, the bandpass filter 50, the control unit 51, and the delay optical transmission lines LC1 to LCn may be configured as an optical transmission line monitoring device. Some or all of the monitoring processing achieved by the optical transmission line monitoring device can be achieved by a general-purpose computer system. This will be briefly described below with reference to FIG. 6.

FIG. 6 is a block diagram illustrating an example of a hardware configuration that achieves a monitoring function of the optical transmission line monitoring device according to the present disclosure. A computer 300 includes, for example, a Central Processing Unit (CPU) 301 which is a control device, a Random Access Memory (RAM) 302, and a Read Only Memory (ROM) 303. The computer 300 further includes an Interface (IF) 304 that is an interface with the outside and a Hard Disk Drive (HDD) 305 that is an example of a nonvolatile storage device. Furthermore, the computer 300 may include an input device such as a keyboard and a mouse and a display device such as a display as other configurations (not illustrated).

The HDD 305 stores an Operating System (OS) (not illustrated) and a control program 306. The control program 306 is a computer program (control program for optical transmission line monitoring) in which a monitoring function of the optical transmission line monitoring system is implemented.

The CPU 301 controls various processing in the computer 300, accesses to the RAM 302, the ROM 303, the IF 304, and the HDD 305, and the like. In the computer 300, the CPU 301 reads and executes the OS and the control program 306 stored in the HDD 305. As a result, the computer 300 achieves a monitoring function of the optical transmission line monitoring system.

The above-described program includes a command group (or software codes) for causing a computer to perform one or more functions that have been described in the present disclosure in a case where the program is read by the computer. The program may be stored in a non-transitory computer-readable medium or a tangible storage medium. As an example and not by way of limitation, the computer-readable medium or the tangible storage medium includes a RAM, a ROM, a flash memory, a Solid-State Drive (SSD) or any other memory technique, a CD-ROM, a Digital Versatile Disc (DVD), a Blu-ray (registered trademark) disc or any other optical disc storage, a magnetic cassette, a magnetic tape, a magnetic disk storage, or any other magnetic storage device. The program may be transmitted on a transitory computer-readable medium or a communications medium. As an example and not by way of limitation, the transitory computer-readable medium or the communication medium includes electrical, optical, acoustic, or propagated signals in other forms.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

Each of the drawings is merely an example for describing one or more example embodiments. Each of the drawings is not associated with only one specific example embodiment, but may be associated with one or more other example embodiments. As those ordinary skilled in the art will appreciate, various features or steps described with reference to any one of the drawings may be combined with features or steps illustrated in one or more other figures, for example, to create an example embodiment that is not explicitly illustrated or described. All of the features or steps illustrated in any one of the figures to explain illustrative example embodiments are not necessarily mandatory, and some features or steps may be omitted. The order of the steps described in any of the figures may be changed as appropriate.

Some or all of the example embodiments described above may be described as, but are not limited to, the following Supplementary Notes.

### (Supplementary Note 1)

An optical transmission line monitoring system including: a first optical transmission line and a first delay optical transmission line for propagating a first monitoring light, a second optical transmission line and a second delay optical transmission line for propagating a second monitoring light, and a detection unit for identifying, based on a time at which the first monitoring light is acquired via the first optical transmission line and the first delay optical transmission line and a time at which the second monitoring light is acquired via the second optical transmission line and the second delay optical transmission line, the first monitoring light as a monitoring light propagated through the first optical transmission line and the second monitoring light as a monitoring light propagated through the second optical transmission line, in which a length of the first delay optical transmission line is different from a length of the second delay optical transmission line.

### (Supplementary Note 2)

The optical transmission line monitoring system according to Supplementary Note 1, further including an output unit for outputting the monitoring light toward the optical transmission line, in which the monitoring light acquired by the detection unit is a return light obtained by reflecting the monitoring light output from the output unit by any of one or more optical repeaters inserted in the optical transmission line.

### (Supplementary Note 3)

The optical transmission line monitoring system according to Supplementary Note 1 to 2, in which a length of the delay optical transmission line is longer than a value obtained by converting a pulse width of the monitoring light into a distance.

### (Supplementary Note 4)

The optical transmission line monitoring system according to Supplementary Notes 1 to 3, in which a length of the delay optical transmission line is shorter than a value obtained by dividing a minimum value of the lengths of the optical transmission lines between the adjacent optical repeaters by the number of the optical transmission lines.

### (Supplementary Note 5)

The optical transmission line monitoring system according to Supplementary Notes 1 to 4, in which the first optical transmission line is a trunk path, and the second optical transmission line is a branch path, a wavelength of the first monitoring light acquired by the detection unit is different from a wavelength of the second monitoring light acquired by the detection unit by a bandpass filter, and the detection unit performs the identification based on a time at which the monitoring light is acquired and a wavelength of the monitoring light.

### (Supplementary Note 6)

The optical transmission line monitoring system according to Supplementary Notes 1 to 4, in which the first optical transmission line is a trunk path, and the second optical transmission line is a branch path, the output unit outputs the first monitoring light and the second monitoring light having wavelengths different from each other, and the detection unit performs the identification based on a time at which the monitoring light is acquired and a wavelength of the monitoring light.

### (Supplementary Note 7)

The optical transmission line monitoring system according to Supplementary Notes 1 to 4, in which the first optical transmission line is a trunk path, and the second optical transmission line is a branch path, and a length of the first delay optical transmission line and a length of the second delay optical transmission line are lengths in which a time at which the first monitoring light is acquired by the detection unit and a time at which the second monitoring light is acquired by the detection unit do not match.

### (Supplementary Note 8)

The optical transmission line monitoring system according to Supplementary Notes 1 to 7, in which the delay optical transmission line is installed in at least one of on the detection unit side from a connection point between the detection unit and the optical transmission line, the output unit side from a connection point between the output unit and the optical transmission line, or inside the optical repeater.

### (Supplementary Note 9)

An optical transmission line monitoring method including: a step of acquiring a first monitoring light via a first optical transmission line and a first delay optical transmission line, and a second monitoring light via a second optical transmission line and a second delay optical transmission line having a length different from the first delay optical transmission line, and a step of identifying, based on a time at which the first monitoring light is acquired and a time at which the second monitoring light is acquired, the first monitoring light as a monitoring light propagated through the first optical transmission line and the second monitoring light as a monitoring light propagated through the second optical transmission line.

### (Supplementary Note 10)

A control program for causing a computer to execute processing of: acquiring a first monitoring light via a first optical transmission line and a first delay optical transmission line, and a second monitoring light via a second optical transmission line and a second delay optical transmission line having a length different from the first delay optical transmission line, and identifying, based on a time at which the first monitoring light is acquired and a time at which the second monitoring light is acquired, the first monitoring light as a monitoring light propagated through the first optical transmission line and the second monitoring light as a monitoring light propagated through the second optical transmission line.

### (Supplementary Note 11)

The optical transmission line monitoring system according to Supplementary Note 5, further including a control unit for controlling a wavelength transmitted by the bandpass filter.

### (Supplementary Note 12)

The optical transmission line monitoring system according to Supplementary Note 6, further including a control unit for controlling a wavelength of the monitoring light output by the output unit.

### (Supplementary Note 13)

The optical transmission line monitoring system according to Supplementary Note 11 or 12, in which each of the plurality of optical transmission lines receives an identification signal indicating either a trunk path or a branch path, and the control unit controls the wavelength based on the identification signal.

Some or all of the elements (e.g., configurations and functions) described in Supplementary Notes 2 to 8 dependent on Supplementary Note 1 and Supplementary Notes 11 to 13 can also be dependent on Supplementary Notes 9 and 10 by the same dependency relationship as Supplementary Notes 2 to 8 and Supplementary Notes 11 to 13. Some or all of the elements described in any Supplementary Note may be applied to various types of hardware, software, recording means for recording software, systems, and methods.

What is claimed is:

1. An optical transmission line monitoring system comprising:
a first optical transmission line and a first delay optical transmission line for propagating a first monitoring light;
a second optical transmission line and a second delay optical transmission line for propagating a second monitoring light; and
a monitoring device, wherein
a length of the first delay optical transmission line is different from a length of the second delay optical transmission line,
the monitoring device includes,
at least one memory, and
at least one processor coupled to the at least one memory, and
the at least one processor identifies, based on a time at which the first monitoring light is acquired via the first optical transmission line and the first delay optical transmission line and a time at which the second monitoring light is acquired via the second optical transmission line and the second delay optical transmission line, the first monitoring light as a monitoring light propagated through the first optical transmission line and the second monitoring light as a monitoring light propagated through the second optical transmission line.

2. The optical transmission line monitoring system according to claim 1, wherein
the monitoring device outputs the monitoring light toward the optical transmission line, and
the monitoring light acquired by the monitoring device is a return light obtained by reflecting the monitoring light output from the monitoring device by any of one or more optical repeaters inserted in the optical transmission line.

3. The optical transmission line monitoring system according to claim 2, wherein a length of the delay optical transmission line is longer than a value obtained by converting a pulse width of the monitoring light into a distance.

4. The optical transmission line monitoring system according to claim 2, wherein a length of the delay optical transmission line is shorter than a value obtained by dividing a minimum value of the lengths of the optical transmission lines between the adjacent optical repeaters by the number of the optical transmission lines.

5. The optical transmission line monitoring system according to claim 4, wherein
the first optical transmission line is a trunk path, and the second optical transmission line is a branch path,
a wavelength of the first monitoring light acquired by the monitoring device is different from a wavelength of the second monitoring light acquired by the monitoring device by a bandpass filter, and
the at least one processor performs the identification based on a time at which the monitoring light is acquired and a wavelength of the monitoring light.

6. The optical transmission line monitoring system according to claim 4, wherein
the first optical transmission line is a trunk path, and the second optical transmission line is a branch path,
the monitoring device outputs the first monitoring light and the second monitoring light having wavelengths different from each other, and
the at least one processor performs the identification based on a time at which the monitoring light is acquired and a wavelength of the monitoring light.

7. The optical transmission line monitoring system according to claim 4, wherein
the first optical transmission line is a trunk path, and the second optical transmission line is a branch path, and
a length of the first delay optical transmission line and a length of the second delay optical transmission line are lengths in which a time at which the first monitoring light is acquired by the monitoring device and a time at which the second monitoring light is acquired by the monitoring device do not match.

8. The optical transmission line monitoring system according to claim 4, wherein the delay optical transmission line is installed in at least one of the monitoring device side from a connection point between the monitoring device and the optical transmission line or inside the optical repeater.

9. An optical transmission line monitoring method comprising:
a step of acquiring a first monitoring light via a first optical transmission line and a first delay optical transmission line, and a second monitoring light via a second optical transmission line and a second delay optical transmission line having a length different from the first delay optical transmission line; and
a step of identifying, based on a time at which the first monitoring light is acquired and a time at which the second monitoring light is acquired, the first monitoring light as a monitoring light propagated through the first optical transmission line and the second monitoring light as a monitoring light propagated through the second optical transmission line.

10. A non-transitory computer-readable medium stored with a control program for causing a computer to execute processing of:
acquiring a first monitoring light via a first optical transmission line and a first delay optical transmission line, and a second monitoring light via a second optical transmission line and a second delay optical transmission line having a length different from the first delay optical transmission line; and
identifying, based on a time at which the first monitoring light is acquired and a time at which the second monitoring light is acquired, the first monitoring light as a monitoring light propagated through the first optical transmission line and the second monitoring light as a monitoring light propagated through the second optical transmission line.
